(19) United States
(12) Patent Application Publication
(10) Pub. No.: US 2006/0245598 A1
(43) Pub. Date: Nov. 2, 2006

(54) Communications headset with programmable keys

(75) Inventor: Jason Batai, Calgary (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 11/117,239

(22) Filed: Apr. 28, 2005

(51) Int. Cl. H04R 1/10

(52) U.S. Cl. 381/74

(57) ABSTRACT

Described is a programmable communications headset. The headset includes a headset body, an earpiece and reconfigurable keys. The headset body is configured for wearing on the head of a user and is adapted to communicate with a headset management system. The earpiece is coupled to the headset body and is adapted to provide audible information to the user. The reconfigurable keys are programmable and are disposed on at least one of the headset body and the earpiece. Each reconfigurable key activates or terminates a communications system function when activated by the user. The communications system function of each reconfigurable key is defined in the headset management system.

### FIELD OF THE INVENTION

The invention relates generally to a telecommunications system. More particularly, the invention relates to a headset having programmable keys used to implement system functions.

### BACKGROUND OF THE INVENTION

Headsets are typically worn by agents and other users in call centers and similar facilities. The headsets allow the wearer to take notes and move about a limited workspace. Typical headsets include one or two earpieces each having an audio transducer or speaker to provide an audible signal. Headsets usually also include a microphone near or at the end of a microphone boom extending from an earpiece. The headset communicates through a telephone set or similar device to enable the user to initiate or receive telephone calls. The telephone set allows the user to select various functions such as mute, transfer, hold and the like. Often multi-line telephone sets include a light to indicate which of multiple telephone lines are currently active. Headsets replace the need for a user to hold a handset, thus the user can more easily take notes. In addition, the user's hands are free to operate a keyboard so that data entry, information searching and similar tasks are made more convenient.

In order to take advantage of the features available on a telephone set, a user generally needs to review an instruction manual or obtain the advice of another to learn how to implement various features. This can represent a significant effort, for example, in a call center where many of the call agents require the same features to be available. In addition, the user has to remain near the telephone set in order to activate a feature. Moreover, supervisors cannot readily determine whether a particular call center agent is engaged in a call, on hold or otherwise available for a call without directly viewing the agent's telephone set.

### SUMMARY OF THE INVENTION

In one aspect, the invention features a programmable communications headset. The headset includes a headset body, an earpiece and a plurality of reconfigurable keys. The headset body is configured for removably attaching to a head of a user and is adapted to communicate with a headset management system. The earpiece is coupled to the headset body and is adapted to provide audible information to the user. The reconfigurable keys are disposed on at least one of the headset body and the earpiece. Each reconfigurable key activates or terminates a communications system function when activated by the user. The communications system function of each reconfigurable key is defined by the headset management system.

In another aspect, the invention features a communications headset that includes a headset body, an audio output device, a reconfigurable key and a programming module. The headset body is configured for removably attaching to a head of a user. The audio output device is attached to the headset body and is adapted for communication with a communications system to provide audible information to a user. The reconfigurable key is disposed on the headset body or the audio output device, and is adapted to activate or terminate a system function when activated by the user. The programming module communicates with the reconfigurable key to dynamically configure the reconfigurable key to perform a mapped communications system function.

In yet another aspect, the invention features a method of configuring a headset to perform one of a plurality of communication systems functions. One of a plurality of reconfigurable keys on a headset is selected. The reconfigurable keys are adapted for communication with a communications system. One of a plurality of communications system functions is selected to be performed when the selected reconfigurable key is activated. A mapping of the selected reconfigurable key to the selected communications system function is stored. In one embodiment, a determination of the selected communications system function mapped to the selected reconfigurable key is made when the selected reconfigurable key is activated and the selected communications system function is performed.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of a networked environment according to an embodiment of the invention in which communications headsets can be configured and operated.

FIG. 2 is an illustration of an embodiment of a communications headset in accordance with the invention.

FIG. 3 is an illustration of another embodiment of a communications headset in accordance with the invention.

FIG. 4 is a flowchart representation of an embodiment of a method for configuring a headset to perform one of a plurality of communication systems functions according to the invention.

FIG. 5 depicts an example of a mapping of keys to available communications system functions.

FIG. 6 is a flowchart representation of an embodiment of a method for using a programmed communications headset according to the invention.

### DETAILED DESCRIPTION

In brief overview the present invention relates to a programmable communications headset and a method for using a programmable communications headset. The headset includes at least one earpiece coupled to a headset body. The headset body allows easy attachment to and removal from a user's head. Keys, or buttons, on the earpiece or the headset body allow the user to activate and deactivate communications system functions. The keys are programmed by an administrator through a headset management system. Keys can be reconfigured at a later time to permit activation and deactivation of different communication system functions. Advantageously, an administrator can quickly and conveniently configure a number of headsets to have access to a common set of communications system functions. Alternatively, the administrator can individually program headsets. Thus users are not required to learn how to configure their headsets. In addition, users experience increased mobility while performing their tasks.

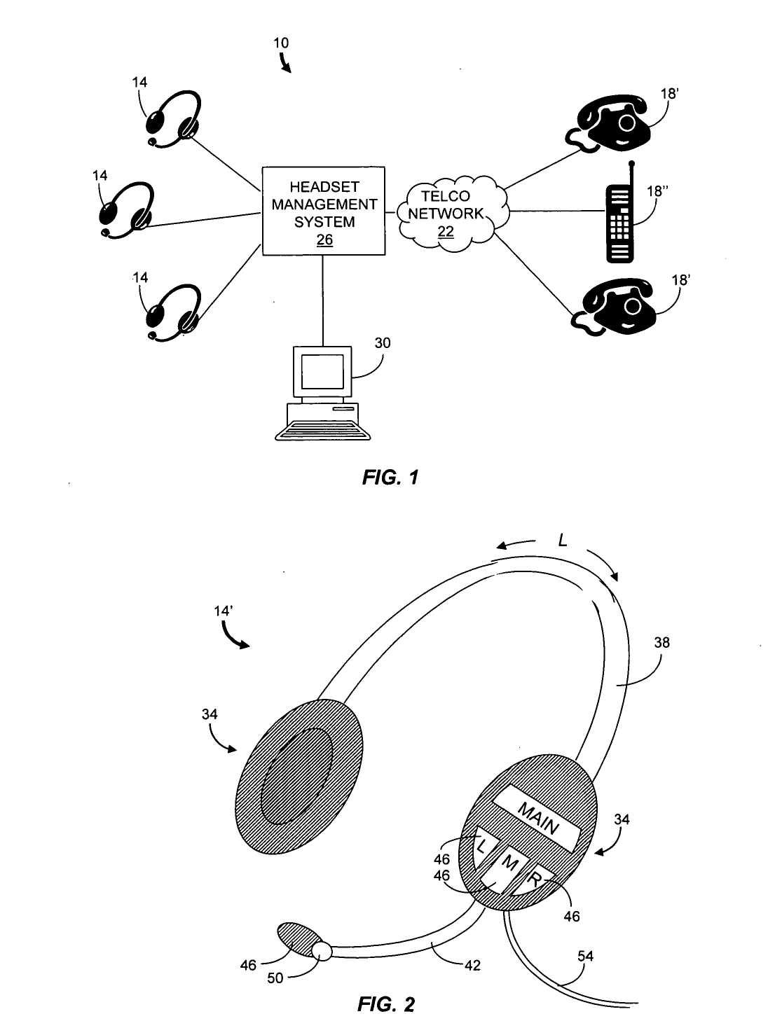

FIG. 1 illustrates a networked environment 10, such as in a call center, in which communications headsets are configured, managed and used for communications according to an embodiment of the invention. Each user communicates through a communications headset 14 with a client communicating through a communications device 18 such as a telephone 18′ or a cellular phone 18″. Communications are routed through one or more telephone company networks 22 which may include landline and wireless communication links. Communications are also routed through a headset management system 26 disposed between the external telephone network 22 and the communications headsets 14. In one embodiment, the headsets 14 communicate through telephones with a telset configuration system that includes the functionality of the headset management system 26 as described in more detail below. Examples of such telset configuration systems include a Nortel Modular Integrated Communication System (MICS), a Norstar Compact Integrated Communication System (CICS) and a Nortel Business Communications Manager model BCM 50. The communications between a headset 14 and the headset management system 26 can be over a wire, a wireless link, or a combination of wire and wireless links. An administrator input/output (I/O) device 30 communicates directly with the headset management system 26. As illustrated, the administrator I/O device 30 is a personal computer (PC) or similar device providing a graphical user interface allowing an administrator interact with the headset management system 26.

FIG. 2 illustrates an embodiment of a communications headset 14′ according to the invention. The headset 14′ includes two earpieces 34 at opposite ends of a headset body 38. The headset body 38 can be expanded or contracted along its length L to accommodate the head of a user. A microphone boom 42 extends from one of the earpieces 34 and includes a microphone 46 and a light emitting diode (LED) 50 near the end of the boom 42 away from the earpiece 34. In the illustrated embodiment, the outside of one of the earpieces 34 is segmented into programmable (i.e., reconfigurable) keys or buttons 46 similar to the upper surface of a mouse used to provide input to a PC. In another embodiment the programmable keys 46 are provided on both earpieces 34. One or more wires 54 extend from one earpiece 34 and provide the communications link to the headset management system 26 and telephone network 22.

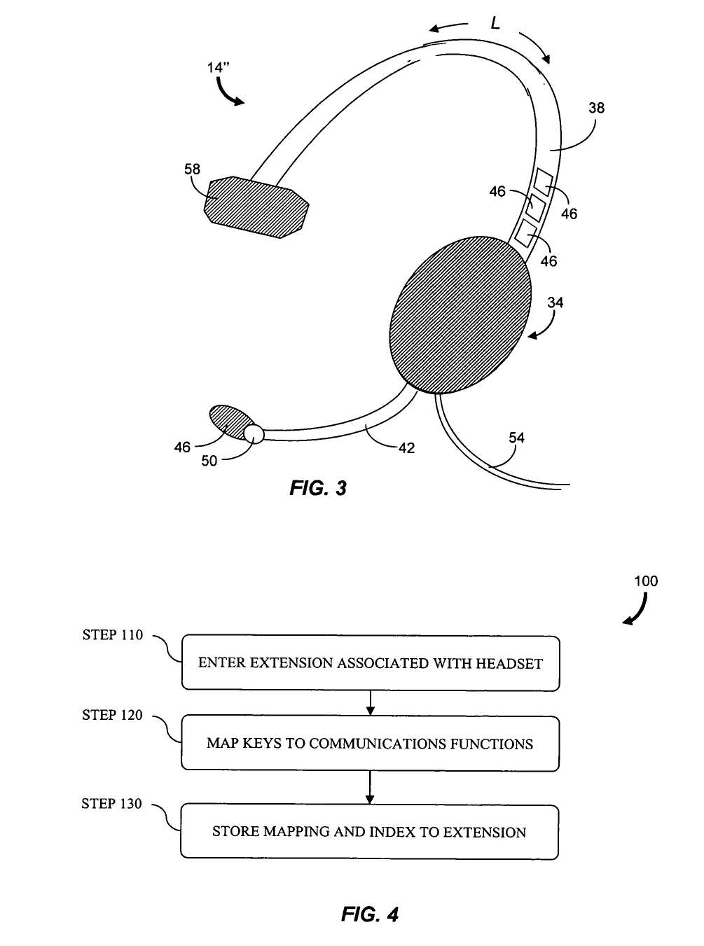

FIG. 3 illustrates a communications headset 14″ according to another embodiment of the invention. The headset 14″ includes a single earpiece 34 at one end of the headset body 38 and a clamp 58 at the other end. The programmable keys 46 are provided along the upper surface of the headset body 38.

During operation of the headset 14 of FIG. 2 or FIG. 3, a user depresses one of the programmable keys 46, for example, to login to or logout from a communications session. The user activates or deactivates a variety of other communications system functions by depressing the other keys 46. Communications system functions include, for example, mute, hold, transfer, request help, and the like. The communications system function associated with each key 46 on the headset 14 can be programmed or reprogrammed by an administrator having access to the headset management system 26 as described in more detail below. If the headset 14 is connected to an incompatible system or is not programmed, the programmable keys 46 provide a default set of system functions. For example, the programmable keys 46 may be hard-coded to provide volume up, volume down and mute features in instances where a headset management system is not detected.

The LED 50 provides a visual indication of the operational status of the headset 14. For example, the LED 50 emits red light to show that the user is currently muted. The LED 50 blinks to indicate another mode such as a caller put “on hold.” In another embodiment, multiple LEDs 50 are provided so that a greater number of operational modes can be represented. Advantageously, a supervisor can monitor the performance of a user by observing the LED 50 from a distance. Personnel near the user can observe the LED 50 to determine whether the user is engaged in a communications session and, therefore, whether the user can be interrupted.

The communications headset 14 offers several advantages over conventional communications headsets. Instead of pressing a button on a telephone on a desk, the user is free to roam about the workplace, limited according to the length of the headset wire 54 or, for wireless headsets, the operating range of the wireless communication link. The most frequently required communications system functions are activated or deactivated by simply pressing the appropriate key 46 on the headset 14. If the headset is connected through a telephone set in the user's workspace, the user enters key sequences on the telephone set to access other communication system features. Moreover, the telephone set may include programmed keys for quick access to a limited number of communications system functions. Thus the number of programmed keys available to the user is effectively increased by the number of programmable keys 46 on the headset. If a user's requirements for communications system functions changes over time, the headset 14 can be reprogrammed, or reconfigured, to provide different functions. Thus a communications facility such as a call center can efficiently manage a large number of communications headsets 14 although the requirements of the users differ and are not static.

Although the illustrated networked environment and headset described above are based on a telephone system implementation, the invention also contemplates a headset that is “universal.” For example, the universal headset can also communicate with one or more other types of communication devices such as a PC and a cellular telephone. In the universal implementation, the headset includes a connector in communication with the headset body. The connector enables the headset to communicate with the predetermined type of external communications device. If the external communications device does not include the functionality of the headset management system (e.g., a cellular telephone), the programmable keys on the universal headset would provide default functions hard-coded during manufacture of the headset.

FIG. 4 shows a flowchart representation of an embodiment of a method 100 for configuring a headset 14 to perform one of a plurality of communication systems functions according to the invention. An administrator responsible for managing communications equipment in a call center uses a PC or other administrator input/output (I/O) device 30 to communicate with the headset management system 26 (see FIG. 1). The extension associated with the headset 14 is selected (step 110) through a graphical user interface (GUI) on an administrator I/O device 30. Optionally, the administrator selects multiple extensions when the corresponding headsets 14 are to be programmed with the same communications system functions. One of the programmable keys 46 on the headset 14 is selected and mapped (step 120) to a communications system function selected from a group of available system functions. The mapping process is repeated for the remaining programmable keys 46. The completed mapping is stored in the headset management system 26 and indexed (step 130) to the extension. If a user later requires a headset with a different communications system function mapping, the administrator recalls the mapping for the user extension and redefines one or more key-function associations.

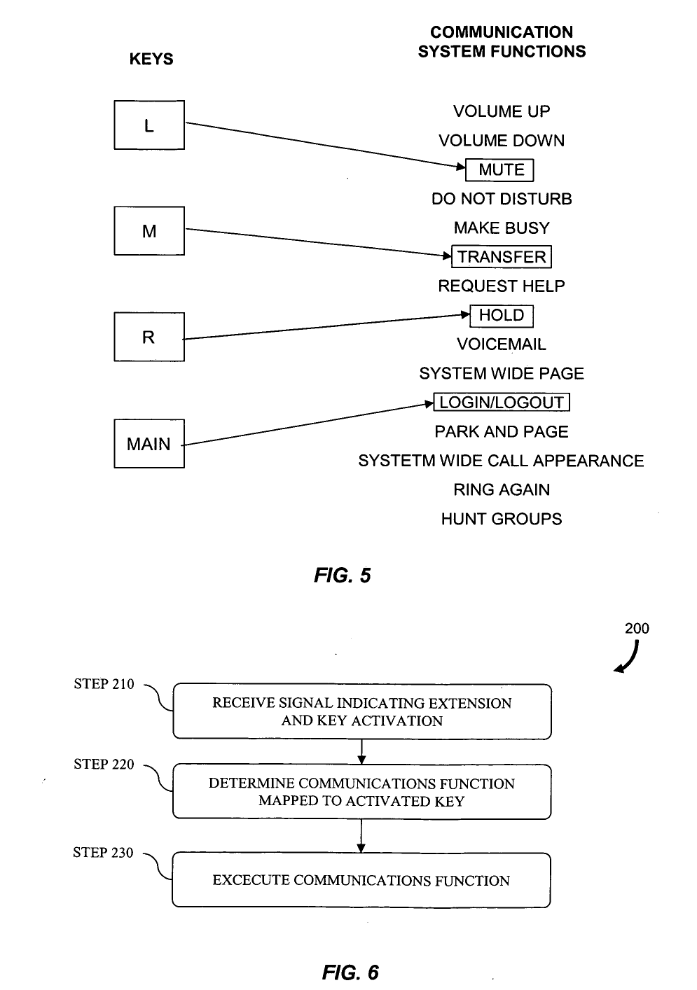

FIG. 5 shows an example of a mapping of keys to communications system functions available for the headset extension and includes functions that can be useful in a call center facility. Keys depicted in the left column with designations “L”, “M”, “R” and “MAIN” and correspond to the keys 46 on the headset 14′ of FIG. 2. The “MAIN” key is mapped to a commonly used function such as login/logout. The “L”, “M” and “R” keys 46 are mapped to mute, transfer and hold functions, respectively. Mute and hold functions can be toggled. More specifically, a user prevents a caller from hearing the user's voice by pressing the “L” key and later the user “un-mutes” the call by again pressing the “L” key. Similarly, the user places a caller on hold by pressing the “R” key. Subsequently, the user presses the “R” key to again speak with the caller.

Referring again to FIG. 1 and to the process flowchart 200 of FIG. 6 to describe the use of a programmed communications headset 14, a user presses a key 14 to activate a communications system function. The headset management system 26 receives (step 210) an indication of the extension and the key activation. For example, the headset 14 causes a stimulus message to be sent from the telephone associated with the extension to the headset management system 26. The communications system function mapped to the key for that extension is determined (step 220) and executed (step 230) for the user. If an activate-deactivate function (i.e., a toggle function) such as login/logout is selected, the headset communications system 26 examines the history of key selections to determine whether activation or deactivation is performed. For example, if the user had last used a key to initiate a session login, the next selection of the same key would result in a logout from the communications session.

While the invention has been shown and described with reference to specific embodiments, it should be understood by those skilled in the art that various changes in form and detail may be made therein without departing from the spirit and scope of the invention.

What is claimed is:

1. A programmable communications headset, comprising:
a headset body configured for removably attaching to a head of a user, the headset body adapted to communicate with a headset management system;
an earpiece coupled to the headset body and adapted to provide audible information to the user; and
a plurality of reconfigurable keys disposed on at least one of the headset body and the earpiece, each reconfigurable key activating or terminating a communications system function when activated by the user, the communications system function of each reconfigurable key being defined by the headset management system.

2. The programmable communications headset of claim 1 wherein the headset management system is adapted to dynamically reconfigure the communications system functions of the reconfigurable keys.

3. The programmable communications headset of claim 1 further comprising the headset management system.

4. The programmable communications headset of claim 3 wherein the headset management system stores a reconfigurable mapping of the reconfigurable keys to the respective communications system functions.

5. The programmable communications headset of claim 1 further comprising an optical device disposed on the headset body to provide a visible indication of an operational status of the programmable communications headset.

6. The programmable communications headset of claim 5 wherein the optical device displays a color responsive to the operational status of the programmable communications headset.

7. The programmable communications headset of claim 5 wherein the optical device is a light emitting diode.

8. The programmable communications headset of claim 1 wherein the headset body comprises a microphone boom and wherein an optical device is disposed on the microphone boom, the optical device providing a visible indication of an operational status of the programmable communications headset.

9. The programmable communications headset of claim 8 wherein the optical device displays a color responsive to the operational status of the programmable communications headset.

10. The programmable communications headset of claim 8 wherein the optical device is a light emitting diode.

11. The programmable communications headset of claim 1 further comprising
a second earpiece coupled to the headset body; and
at least one reconfigurable key disposed on the second earpiece to activate or deactivate one of the communications systems functions when activated by the user.

12. The programmable communications headset of claim 1 further comprising a connector in communication with the headset body, the connector being adapted to communicate with a predetermined type of external communications device.

13. The programmable communications headset of claim 12 wherein the external communication device comprises a computer.

14. The programmable communications headset of claim 12 wherein the external communication device comprises a cellular telephone.

15. The programmable communications headset of claim 1 wherein the reconfigurable keys activate or terminate a default communications system function when activated by the user if no headset management system is in communication with the headset body.

16. A communications headset comprising:
a headset body configured for removably attaching to a head of a user;
an audio output device attached to the headset body and adapted for communication with a communications system to provide audible information to a user;
a reconfigurable key disposed on one of the headset body and the audio output device, and being adapted to activate or terminate a system function when activated by the user; and
a programming module in communication with the reconfigurable key for dynamically configuring the reconfigurable key to perform a mapped communications system function.

17. A method of configuring a headset to perform one of a plurality of communication systems functions, the method comprising:
selecting one of a plurality of reconfigurable keys on a headset adapted for communication with a communications system;
selecting one of a plurality of communication system functions to be performed when the selected reconfigurable key is activated; and
storing a mapping of the selected reconfigurable key to the selected communications system function.

18. The method of claim 17 further comprising:
determining the selected communications system function mapped to the selected reconfigurable key when the selected reconfigurable key is activated; and
performing the selected communications system function.

19. The method of claim 17 wherein the selection comprises selecting the communications system function through a graphical user interface executing on a computer.

20. The method of claim 17 further comprising providing a visual indication of an operational status of the headset.
